(19) United States
(12) Patent Application Publication
(10) Pub. No.: US 2004/0069570 A1
(43) Pub. Date: Apr. 15, 2004

(54) Mist distributor with integral air solenoid valve

(76) Inventor: John Baumann, Islip, NY (US)

Correspondence Address: SCHWEITZER CORNMAN GROSS & BONDELL LLP, 292 MADISON AVENUE - 19th FLOOR, NEW YORK, NY, 10017, US

(21) Appl. No.: 10/269,819

(22) Filed: Oct. 11, 2002

(51) Int. Cl. F16N 7/30

(52) U.S. Cl. 184/55.1

(57) ABSTRACT

A lubricator apparatus comprises a tank having a lower portion forming a reservoir for lubricating oil to be combined with compressed air to form a lubricating air-oil mist. The tank bottom has a surface exposed to the lubricating oil in the tank and an air passageway therethrough between an air inlet and an air outlet through which the compressed air is passed before it enters the tank. A solenoid valve is mounted in a heat-transfer relationship to the tank bottom, the valve operatively controlling the air passageway, whereby heat generated by solenoid operation is transferred to the lubricating oil to raise the temperature of the oil. The tank bottom may also include a filter and condensate drain system to filter the compressed air and remove moisture therefrom.

The present invention relates to the textile arts and in particular to an air-oil mist distributor apparatus for use in connection with industrial textile machinery.

### BACKGROUND OF THE INVENTION

The use of air-oil mist distribution devices for the lubrication of industrial textile machinery and the like is well known. Such lubricating devices combine oil with a pressurized air flow to create a mist or aerosol which is then directed through a manifold and piping to require lubrication points on the machinery. Control devices may be utilized to meter the flow and to channel the flow, alternatively, sequentially, or simultaneously, to the various discrete lubrication areas of the machinery.

Air flow through the distributor apparatus is controlled by a solenoid valve device. An air line connects the valve to the distributor. The air is then passed through an oil reservoir located at the bottom of the distributor, forming an air-oil mist, and the air-oil mist is then piped from the distributor to the equipment to be lubricated. Because the flow characteristics of the lubricating oil are in part temperature dependent, the lubricating efficiency of such systems has been found to vary in accordance with the ambient temperature. At lower temperatures the oil becomes more viscous, and at a given air flow rate the resulting mist bears less oil and thus provides less efficient lubrication. In addition, the mist oil also flows less efficiently when it contacts the machinery.

It is accordingly a purpose of the present invention to provide an improved air-oil mist distributor apparatus that can maintain the lubricating oil at an elevated temperature for improved flowability characteristics.

A further purpose of the present invention is to provide an improved distributor apparatus having an integral air control valve.

Yet a further purpose of the present invention is to provide an improved distributor apparatus in which electrical losses previously associated with solenoid-type air valves can be harnessed to provide useful heat energy.

Yet another purpose of the present invention is to provide an improved distributor apparatus having an integral compressed air conditioning and control system.

### BRIEF DESCRIPTION OF THE INVENTION

In accordance with the foregoing and other objects and purposes, an air mist distribution apparatus of the present invention comprises a housing of generally conventional configuration having an integral oil reservoir at its lower end. An electrically-operated air solenoid valve is rigidly mounted to the bottom of the apparatus, and stands in a heat-transfer relationship thereto. Resistive and inductive heat generated by the operation of the solenoid is conducted to the lower portion of the housing and thus to the oil therein, raising the temperature of the oil and thus improving its flow characteristics. In addition, as the apparatus base serves as a heat sink for the solenoid, the solenoid operates at a lower temperature than a free-standing unit, thus improving its life. At the same time, the heat generated through operation is not lost, but is channeled to the oil. In a preferred embodiment the apparatus base also may include a filtering and moisure removal system for the air.

### BRIEF DESCRIPTION OF THE DRAWINGS

A fuller understanding of the present invention will be accomplished upon review of the following detailed description of a preferred, but nonetheless illustrative embodiments thereof, when taken in conjunction with the annexed drawings, wherein:

FIG. 1 is a perspective view of a distributor apparatus in accordance with the invention;

FIG. 2 is a partial sectional view of the lower portion of the distributor apparatus;

FIG. 3 is a section view taken along line 3-3 of FIG. 2; and

FIG. 4 is a section view taken along line 4-4 of FIG. 3.

### DETAILED DESCRIPTION OF THE INVENTION

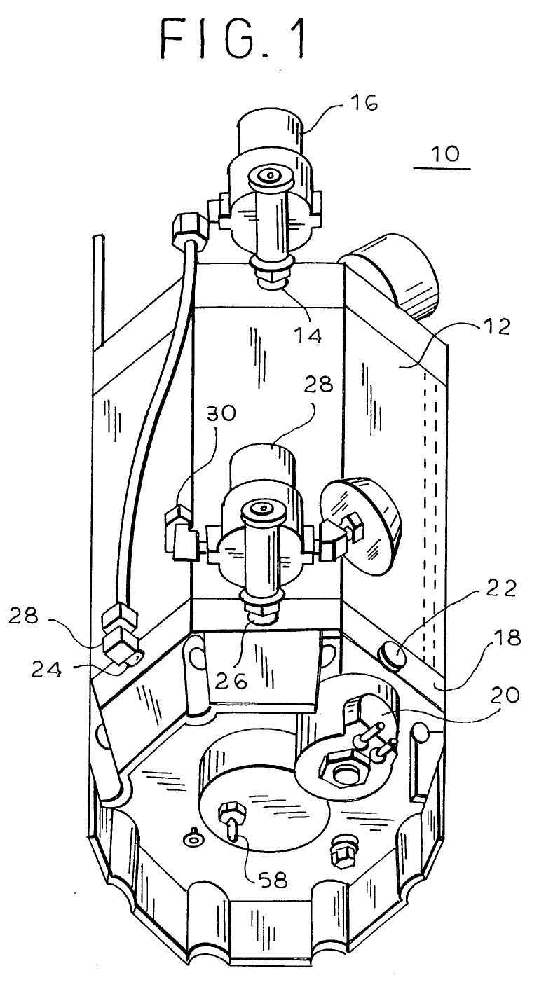

With initial reference to FIG. 1, air-oil mist lubricator 10 includes a main tank 12 serving as a reservoir for lubricating oil to be distributed as required. The tank is provided with an air inlet 14 at its upper end, which may include a regulator 16. The compressed air is combined with the oil to provide an air-oil mist or aerosol which is directed through a manifold system at the upper end of the lubricator (not shown) for delivery as required. In prior art devices the input to the air inlet 14 comprises a tube running from a remotely-located solenoid valve.

In accordance with the present invention, lubricator bottom piece 18 supports solenoid valve assembly 20, with a top housing surface mounted flush against the lower surface of the bottom piece 18. Bottom piece 18 is also provided with an integral air inlet 22 and a pair of air outlets 24, 26. A fitting 28 is connected to outlet 24, and feeds the air to regulator 16 and thus to inlet 14, while outlet 26 may either be capped or, as shown in the figure, provided with a regulator 28 to provide a source of compressed air through fitting 30 for other purposes.

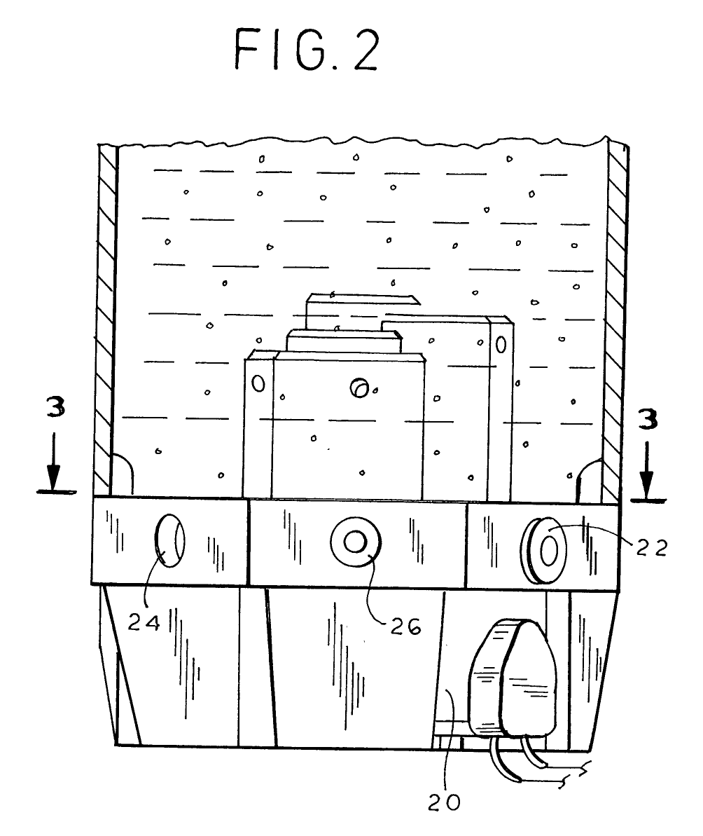

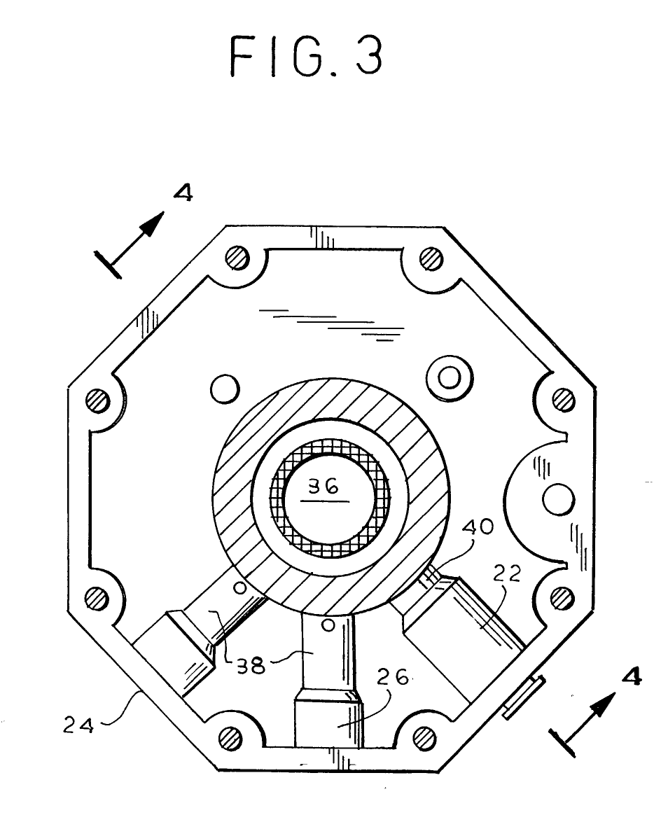

With further reference to FIGS. 2-4, solenoid valve 20 includes windings 32 which generate a magnetic field to operate valve armature 34, as known in the art. When activated, the source of compressed air attached to air inlet 22 is connected to passageway 40 within the lubricator bottom piece 18 which allows the compressed air to travel through the interior of the bottom piece and then subsequently out through passageways 38 to the outlets 24 and 26.

As the housing for solenoid valve assembly 20 is in intimate contact with the cast and machined lubricator bottom piece 18, the ohmic heating generated during operation of the solenoid winding 32 is conducted through the bottom piece 18. This serves both to draw such heat from the solenoid, moderating its operating temperature, as well as to heat the bottom piece. As the upper surface of the bottom piece is in contact with the reservoir oil 38, the oil is also heated by the bottom piece. As the density of the oil decreases upon heating, convection currents arise in the oil, serving to further distribute the heat energy through the oil and transfer the heat through the oil. In addition, as the air passageways 38 and 40 also formed within the bottom piece 18, some degree of heating of the air is also performed, further assisting in elevating the temperature of the resulting air-oil mist to maintain the improved viscosity characteristics of the transmitted oil.

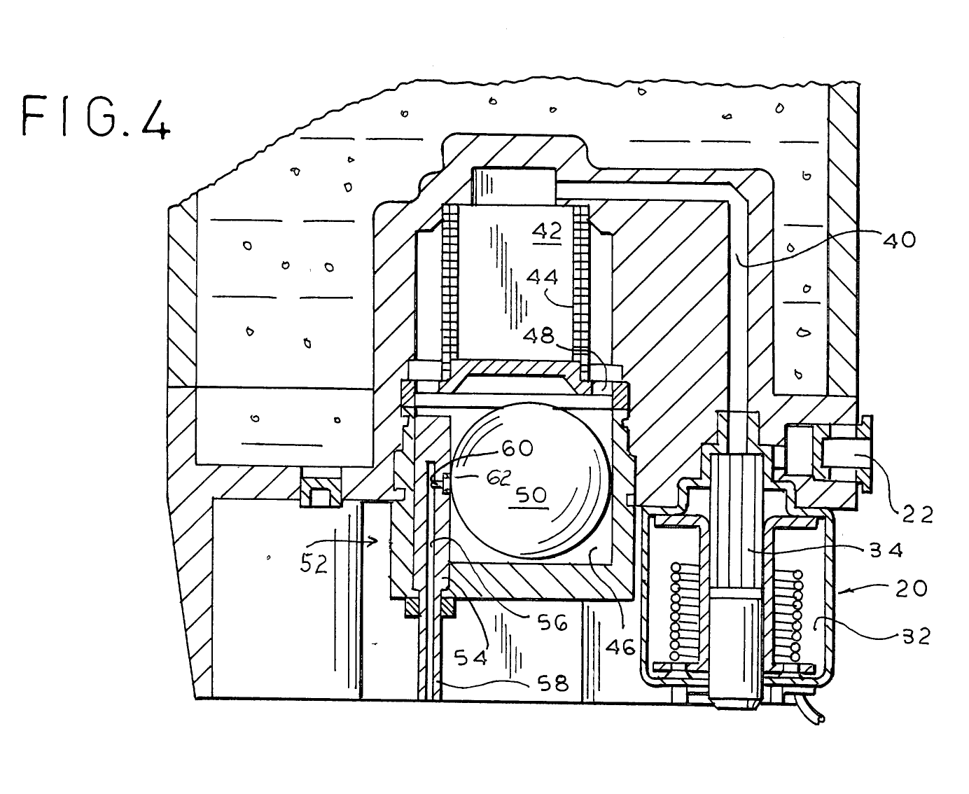

Preferably, the lubricator bottom piece is of a construction that, in addition to supporting the solenoid valve 20, includes means for filtering the compressed air and removing moisture therefrom. Thus, and as seen in FIG. 4, the bottom piece includes a first chamber 42 in which air filter 44 is mounted. The compressed air is introduced into the center of the chamber through passageway 40 and passes through the filter. A second generally cylindrical chamber 46 lies below the first chamber, and is connected thereto by ports 48. The second chamber serves as a sump for condensate removed from the compressed air as it passes through the distributor apparatus. Valve float ball 50 is located in the second chamber, along with drain tube assembly 52. The first chamber may be formed directly in the bottom piece, while the second chamber may be formed by a cast or machined sub-assembly mounted within an accepting aperture in the bottom pieces.

Drain tube assembly 52 includes a cylindrical shaft 54 having internal drain line 56. The shaft terminates at barb fitting 58, exterior to the bottom piece, through which the drain line exits and to which a hose to an external collector or drain may be attached. The drain line is also provided with an inlet bore 60 extending through the shaft sidewall, having a surrounding o-ring seal 62. The o-ring projects slightly proud of the shaft. The drain tube assembly is mounted such that the inlet bore 60 is aligned with the horizontal centerline of float ball 50 when the float ball rests on the bottom of chamber 46, the float ball sealing the inlet bore. The diameter of the chamber is chosen to provide limited clearance between the ball and the chamber sidewall.

With the float ball sitting on the chamber bottom and compressed air passing through the chamber, the pressure differential between the chamber interior and atmospheric pressure which appears at the inlet bore 60 causes the ball to be held snugly against the o-ring seal 62, closing the drain line and preventing the compressed air from escaping therethrough. At an operating pressure of about 100 psi, an inlet bore of about 0.042 inch provide a sufficient maintenance force for a ball having a diameter of about 1.4 inch. During continued distributor operation, moisture in the compressed air tends to condense on the interior surfaces of the two chambers, as well as on the filter, and flows into and collects at the bottom of the second chamber. The mass and size of the ball are such that the buoyancy effects on the ball by the collected water is insufficient to float the ball and overcome the force imbalance holding the ball against the inlet bore 60 until somewhat more than one-half of the ball is submerged. At that point the ball floats, exposing the drain line, and the water level, which is above the inlet bore, drains out through the line until the buoyancy is lost, the ball again resting on the bottom of the chamber and the drain line is re-closing by the ball. Thus in operation the second chamber maintains a water level slightly below the height of the inlet bore, the chamber automatically flushing additional water out through the drain line as it is collected.

I claim:

1. A lubricator apparatus, comprising a tank, a lower portion of the tank forming a reservoir for lubricating oil to be combined with compressed air to form a lubricating air-oil mist; a tank bottom having a surface exposed to the lubricating oil in the tank and an air passageway therethrough between an air inlet and an air outlet; and a solenoid valve mounted in a heat-transfer relationship to the tank bottom, the valve operatively controlling the air passageway, whereby heat generated by solenoid operation is transferred to the lubricating oil to raise the temperature of the oil.

2. The lubricator apparatus of claim 1 further comprising a tank air inlet to the tank interior, the air outlet being coupled to the tank air inlet.

3. The lubricator apparatus of claim 1 wherein the tank bottom further includes an internal cavity coupled to the air passageway, the internal cavity having an air filter.

4. The lubricator apparatus of claim 2 wherein the air passageway is in a heat transfer relationship with the tank bottom to effect heating of air in the passageway.

5. A method for providing an air-oil lubricating mist to machinery locations to be lubricated, comprising the steps of:
providing compressed air to a lubricator apparatus having a tank resevoir for the oil and a tank bottom with an air passageway therethrough controlled by a solenoid valve mounted to the tank bottom in a heat-transfer relationship;
operating the valve to control the passage of the compressed air through the lubricator and generate heat;
conducting the heat through the tank bottom to oil in the reservoir to raise the temperature of the oil; and
combining the compressed air with the oil in the reservoir to form an air-oil mist to be distributed to the machinery locations.

6. The method of claim 5 further comprising the step of conducting a portion of the heat to the compressed air as it passes through the air passage in the bottom to effect heating of the air before the air is combined with the oil.

7. A lubricator apparatus, comprising a tank, a lower portion of the tank forming a reservoir for lubricating oil to be combined with compressed air to form a lubricating air-oil mist; a tank bottom having a surface exposed to the lubricating oil in the tank and an air passageway therethrough between an air inlet and an air outlet; an air filter and a condensate trap located in the tank bottom, and a solenoid valve mounted in a heat-transfer relationship to the tank bottom, the valve operatively controlling the air passageway, whereby heat generated by solenoid operation is transferred to the lubricating oil to raise the temperature of the oil.

8. The apparatus of claim 7 wherein the condensate trap comprises a chamber in the tank bottom, and a float ball and drain tube assembly located within the chamber.

9. The apparatus of claim 8 wherein the drain tube assembly includes an inlet located to be in contact with a main horizontal circumference of the ball when the ball rests upon the bottom of the chamber.
